(19) United States
(12) Patent Application Publication
(10) Pub. No.: US 2006/0227336 A1
(43) Pub. Date: Oct. 12, 2006

(54) Apparatus and methods for preparing customized personal supports

(76) Inventors: Todd M. Dinner, Erie, PA (US); Donald C. Neth, Hudson, OH (US)

Correspondence Address: HUDAK, SHUNK & FARINE, CO., L.P.A., 2020 FRONT STREET, SUITE 307, CUYAHOGA FALLS, OH, 44221, US

(21) Appl. No.: 11/100,296

(22) Filed: Apr. 6, 2005

(51) Int. Cl. G01B 11/24

(52) U.S. Cl. 356/601

(57) ABSTRACT

An apparatus for determining the surface contour of an impression of a portion of a body in an impression capturing device. The apparatus includes a light source such as a laser capable of transmitting a beam onto a surface of a device, a digital stereo vision camera capable of recording the surface contour of the surface as it is being scanned by the laser beam, and a digital conduit capable of transmitting the camera digital signal to a microprocessor for processing and/or storing contour data of the surface. The data can be utilized for making a support article such as seat or cushion having the same contour as the personal support article.

### FIELD OF THE INVENTION

The present invention relates to an apparatus capable of forming a body support article such as a seat cushion. More specifically, the present invention relates to an apparatus comprising a contour scanning system using a light source such as a laser beam to scan the surface contour of an impression in a workpiece, such as in an impression capturing device, thereby allowing a digital stereo vision camera and microprocessor of the apparatus to record the contour and to convert it to a digital signal or data. The digital signal or data generated can be stored in the microprocessor for later use or transmitted directly to a fabricating unit in order to form or fabricate a support article having the same contour as the scanned article. The invention is particularly useful for making seat cushions and personal support articles having a desirable contour for a handicapped person or a person having a deformed body, etc., for making various braces for a human body or extremity thereof, and the like.

### BACKGROUND OF THE INVENTION

Heretofore, specially designed or custom made seats for disabled, physically challenged, etc. persons have been made using generally mechanical recording devices for imitating the surface contour of a desired seat.

U.S. Pat. No. 4,972,351 relates to a system for reportedly generating prescription wheelchair seats or specialized seating or body supports. The system includes a deformable seat portion which is formed to specialized dimensions of a seated patient. A planar, linear, array of linear transducers is stepped across the form in one dimension forming a series of signals representative of generally planar cross sections of the form. This series of cross-sectional signals is provided as an input to a numerically controlled cutting device which cuts a series of sheet stock foam in accordance with each cross-sectional area measured. These cross-sectional pieces are then assembled into the prescription seat.

U.S. Pat. No. 6,383,148 relates to a method of measuring a body region of a human body which includes recording at least two images of the body region from different camera positions, from which the contour lines are ascertained, for example, as a contrast. Used for scaling the images is a reference object with a reference zone, to which the camera is set in a perpendicular or near perpendicular viewing direction by means fan angle-determining device. The reference zone can be defined, for example, by perpendicularly protruding fins. From the projected images of the contour line and the reference zone, an individual model of the outside surface of the body region is reportedly subsequently ascertained by means of the reference model. From this individual model a prosthesis or orthesis can be reportedly fabricated. Limb stumps are scanned in an unloaded state and not bearing any weight. No distortions in shape occurring in a load bearing situation are accounted for.

U.S. Pat. No. 4,890,235 relates to a system for generating a prescription wheelchair or other seating or body support arrangement including a deformable seat portion. A patient to be fitted with the wheelchair is placed upon the seat deforming a surface thereof. A signal representative of force distribution resultant from the patient along the seat is generated. In accordance with this signal, the seat surface can be selectively varied by a plurality of pneumatic actuators. An updated force distribution signal is generated. In this fashion, a means and method is provided for arriving at pre-selected force distribution of the patient on the wheelchair seat. This data is made available for transmission to a fabrication unit from which a permanent seat cushion with the desired characteristics can be fabricated.

### SUMMARY OF THE INVENTION

An apparatus utilizing laser and digital imaging technology for capturing the surface contour of a desired personal support article such as a seat cushion, body brace, and the like is described. In order to provide a distinct capture lighted area for a digital stereo vision camera capable of depth determination, a light source such as a laser capable of projecting a beam preferably a linear beam is utilized to scan the contour of a selected workpiece, such as located on an impression capturing device. Data points are produced with the scanning laser beam which is recorded digitally by the stereo vision camera, which contains at least two separate independent digital camera lenses for depth determination, and transmits a digital signal via a digital conduit to a microprocessor for processing and/or storing. The data for the image is transferred such as by an electronic communication, for example e-mail, to another location where it can be transferred to a fabricating machine for making a personal support article.

The present invention also relates to an apparatus for determining the surface contour of an impression of a portion of a body, including a light source capable of projecting a beam onto a surface comprising at least an impression of a portion of a body; and a contour scanning system comprising at least two digital cameras spaced a predetermined distance from each other and operatively connected to a microprocessor, said contour scanning system capable of detecting the beam on the surface and generating a plurality of data reference points relating to the contour of the surface.

In a further embodiment, the present invention relates to an apparatus for determining the surface contour of an impression of a portion of a body, including a laser light source capable of projecting a laser beam onto and scanning a surface of a device comprising an impression of a portion of a body; a digital stereo vision camera capable of recording images of the surface contour of the surface as said laser beam scans the surface of said device; and a digital conduit capable of operatively connecting said digital stereo vision camera to a microprocessor.

In yet another embodiment, the present invention relates to a method for preparing a support article, including the steps of forming an impression of a body part in an impression capturing device; scanning at least a surface of the impression with a beam from a light source; and determining location of one or more points scanned with the light source beam on at least the surface of the impression utilizing a contour scanning system.

### DESCRIPTION OF THE DRAWINGS

The invention will be better understood and other features and advantages will become apparent by reading the detailed description of the invention, taken together with the drawings, wherein:

FIG. 1 is a side view of one embodiment of the present invention, wherein a contour scanning system is illustrated in the process of scanning an impression located on an impression capturing device so that a personal support article can be fabricated from the data produced by the contour scanning system.

FIG. 2 is a top view of the apparatus illustrated in FIG. 1.

FIG. 3 is a front elevational view of a support article fabricated in accordance with the present invention.

### DETAILED DESCRIPTION OF THE INVENTION

The surface contour of numerous different types of personal support articles is replicated by an apparatus including a contour scanning system utilizing a light source capable of emitting a light beam having greater illuminating power or brightness than the ambient light, preferably a laser; a digital stereo vision camera, and a digital conduit for transmitting a digital signal to a microprocessor or computer. The personal support article includes seats, chairs, body or extremity support articles, braces, cushions, and the like that are utilized for comfort, medical reasons or therapeutic reasons whether or not a person is physically challenged, injured, or is able bodied. The present invention thus relates to manufacturing at least one desired personal support article utilizing the apparatus described herein. While the present invention will be described with regard to a seat cushion to support a person's posterior or a back cushion for supporting an individual's back, it is not limited thereto and generally can be utilized to make any personal support article.

In order to produce a seat and/or back cushion having a suitable or custom fit with regard to a particular individual, an impression of a contour of a portion of a person's body in a predetermined position is made in any conventional manner. One such method involves utilizing an impression capturing device capable of retaining an impression of a portion of a person's body, such as a bead or bean bag seat, wherein particles such as beads, beans or the like are contained within a flexible cover such as latex, plastic, leather or the like. The person is placed in a seated position upon the impression capturing device in order to create and capture an impression of a contour of a portion of the person's posterior or backside. The impression capturing device is massaged or manipulated to provide the required support for the individual and then the impression of the desired body contour is captured or maintained. In one embodiment the numerous particles are “frozen” into position through the application of a vacuum. to the impression capturing device. This capturing of the impression permits the person to be removed from the device without destroying the impression. The impression captured by the device is utilized as a surface contour for the present invention. Impression capturing devices are available from Otto Bock of Minneapolis, Minn., Invacare of Elyria, Ohio and Prairie, for example.

In a further step, the impression in the impression capturing device as well as any desired surrounding structure are scanned utilizing the contour scanning system of the present invention, and the data resulting from the scan is subsequently utilized to form a support article utilizing a fabricating unit. In order for the digital stereo vision camera of the contour scanning system to determine and record depth variations, a reference plane is determined. This can be accomplished in a number of ways. A convenient way is to utilize a flat surface, framework, board, planar elements, etc., as the base for the impression captured with the impression capturing device. The contour scanning system is utilized to record at least three points of the plane of the base to establish a reference plane.

In order that the molded shape surface of the impression capturing device can be recorded utilizing the digital stereo vision camera, a light source such as a laser beam is utilized to highlight points on the surface so the contour scanning system can capture data points along the mold contour of the impression. The laser beam produces a bright contrast when compared to the remaining contoured portions of the impression capturing device so that the camera can readily respond to the bright laser light. In order to provide a good resolution of the image to the camera and to provide high resolution of the contoured surface, the camera connected to the microprocessor is programmed to recognize and process light above a predetermined threshold value and determine reference points for the physical location of distinct points on the impression capturing device relative to the camera. Thus, room light, background light, and/or sky light or the like can be effectively ignored or eliminated.

The isolation of distinct points on the impression capturing device surface is required for the camera and microprocessor of the contour scanning system to determine and record data points for future fabrication of a support device. The use of a light source having a relatively moderate or large area of light presents a problem inasmuch as a relatively homogenous collection of pixels is recorded as opposed to a collection of relatively precise, distinct points. A solution is desirably the utilization of a light source, such as commercially available laser which projects a relatively narrow point, but more preferably a narrow beam or line of light onto a surface of the impression capturing device. The width of the beam is generally less than about 2 or about 1 centimeter and desirably is between about 2 to about 8 millimeter(s), and preferably is about 5 millimeters at a distance of about 2 meters from the beam source. The length of the height or column of the beam can vary from about 1 to about 60 centimeters and desirably from about 2 to about 24 centimeters at a distance of about 2 meters from the beam source. In one embodiment, the laser is a diode laser, such as a red, green or other colored diode laser having a wavelength generally from about 500 or 600 to about 800 or about 1000 nm, and preferably from about 650 to about 680 nm. In one embodiment the laser has a power generally from about 1 to about 10 mW and preferably from about 4 to about 5 mW. In a preferred embodiment, a lens, such as a negative cylindrical lens is utilized to produce a beam having a predetermined height and width at a desired distance. In one embodiment, a negative cylindrical lens having a focal length of 3 cm is utilized. Suitable linear lasers are available from Lighting Sciences Canada Ltd. of Waterloo, Ontario, Canada.

The light sources utilized in the present invention such as laser pointers or linear laser beams effectively cast or paint a point, line or column, etc., onto a surface of the impression capturing device to be reproduced. The light source is scanned, preferably manually, across the surface of the impression capturing device comprising the impression to provide a moving point, line or column of light which is processed by the contour scanning system comprising the digital stereo vision camera to determine the displacement of adjacent surfaces and to record a three-dimensional image including depth and elevation of the contour surface. While the light source can be projected from left to right, and top to bottom of the impression in the impression capturing device, in one embodiment a machine can be utilized to accomplish the same so that the manual scanning movement across the contoured surface is at the relatively same speed.

In order to convert the reference points illuminated on the impression capturing device into three-dimensional signals or data points, the digital stereo vision camera is utilized. Two or more individual cameras could be used if calibrated. Such digital stereo vision cameras must contain at least two lenses, with two being preferred, with each lens being spaced apart from each other and operated independently of each other. The separate lenses each capture an image by recording the linear laser beam location on the surface of the impression capturing device and obtaining a parallax. The depth of surface variations on the impression cutting device surface is thereby determined. Since the cameras are digital cameras, they constantly record a digital image or display of the contour surface highlighted by the laser beam. Such cameras are commercially available as a Bumble Bee™ manufactured by Point Grey Research of Vancouver, British Columbia which has a resolution of 640×480 pixels at 30 Hz frame rate or 1024×768 pixels at 15 Hz frame rate, for example. A further stereo vision camera system is described in U.S. Pat. No. 6,392,688 herein incorporated by reference. The contour scanning system comprising the digital stereo vision camera converts the reference points into a digital signal and can perform any number of captures per second and generally from about 1 to about 20,000 captures per second and preferably from about 20 to about 16,000 captures. The noted Bumble Bee™ camera performs approximately 30 to about 16,000 captures per second. Such cameras are provided with software to convert captured video images from each lens which are then correlated with each other as well as the base or reference plane to provide three-dimensional images of surfaces in the form of a digital electronic signal.

The digital signals from the digital stereo vision camera are transmitted to a microprocessor for processing and/or storage. The microprocessor includes hardware and software for processing, storage, retrieval, and display of the data, as understood by one of ordinary skill in the art. Any conventional digital conduit can be utilized to transmit such signals and the same are known to the art and to the literature. An example includes a FireWire i.e. IEEE 1394, cable. The cable can also provide power to the camera. Other cameras may use a separate power source.

The digital cameras described hereinabove available from Point Grey Research are provided with a software development kit, such as Digiclops™ and Triclops™, designed to be utilized on the microprocessor having an operating system such as Windows (Microsoft) or Linux. The software development kit is used for image acquisition, control over camera settings including, but not limited to, video mode, format, frame rate, and image color processing. The software development kit, includes a full application programming interface which allows for control of the camera parameters. Utilizing the software development kit, real-time depth and 3D images of desired portions of the impression captured in the impression capturing device can be acquired and displayed, and 3D models can be built based on the image data acquired. The contour scanning system is able to create exact range values for every pixel in the image. The contour scanning system is utilized to produce information such as the distances to the impression capturing device and sizes, dimensions and orientations of the impression and any other desired structure can be determined using triangulation.

The microprocessor which is utilized can be any conventional microprocessor or central processing unit known to the art and to the literature such as those manufactured by DELL, Gateway, IBM, Macintosh, Hewlett Packard, or the like, preferably utilizing a Windows operating system. The microprocessor comprising the software which converts such data into the computer memory also includes a user interface that provides an interactive video display of the scanned surface. It is also desirable to have an interactive display of the surface as a three-dimensional mold.

Data is acquired of the impression captured in the impression capturing device in one embodiment as follows. The camera system is initialized in an automatic mode. The cameras are then directed at the impression capturing device. A reference plane is then determined. Three or more reference points, preferably on the impression capturing device, which lie substantially in the same plane, are chosen and scanned with the laser beam of the light source. The contour scanning system detects the beam at each reference point and utilizes vectors or triangulation to define the reference plane. More specifically, the cross product of the two vectors results in a vector perpendicular (normal) to the reference plane. The normal vector and any single known point are used to determine the equation of the reference plane. In further steps, data points are determined within an area of interest on the impression capturing device, such as the seat base portion or seat back portion in an acquisition mode. The laser beam is scanned again on the surface of the impression capturing device in the area of interest. Concurrently, the contour scanning system searches the image of the impression capturing device line by line for essentially the brightest point in each row of pixels, which are then captured and recorded. The data is then processed to generate a set of data relating to the impression for further use in fabricating a personal support article therefrom. The dot product of the normal vector and the z unit-vector is used to determine the angle by which the reference plane deviates from the XY plane. The entire point cloud is rotated around its centroid to align it with the XY plane. The rotated point cloud is then sampled on fixed x-y intervals. The average z value of points in the neighborhood of each x,y pair is used as the final z value for that pair. The result is an array of evenly spaced points in the XY plane with varying displacements in the z direction. The data is written to a file for later use in one embodiment. This format is compatible with three-dimensional milling approaches.

Referring now to the drawings, the overall operation of the invention will be explained. An impression of a desired portion of a person's body such as one's buttocks, upper legs, and/or spine or the like is made in any conventional manner as by utilizing the impression capturing device 50 described hereinabove. As illustrated, impression 57 is located on the seat base portion 56 of impression capturing device 50. In the embodiment illustrated, the impression capturing device 50 includes a vacuum 59 which is utilized to maintain an impression after creation. The impression in this example contains a contour of the posterior of a person when seated and thus has depressions which conform to the buttocks and various other conformations such as a ridge which corresponds to a raised portion between a person's thighs. Inasmuch as the impression is of a particular individual, it will conform to any deformities or different shapes, etc., of that individual.

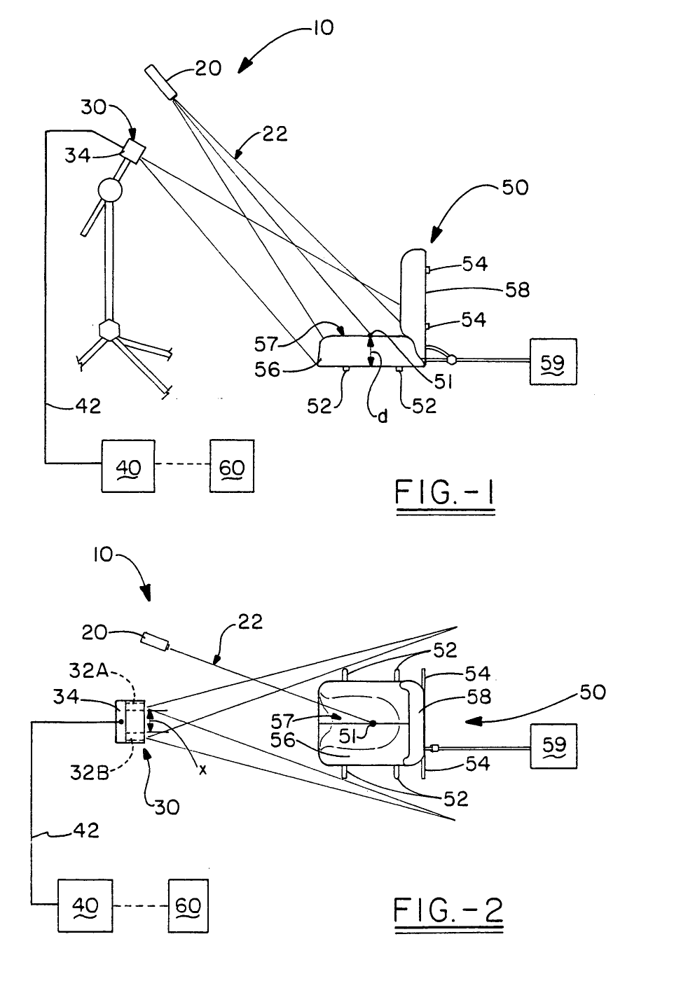

FIGS. 1 and 2 illustrate a side view and a top view respectively of the apparatus of the present invention including contour scanning system 10 for measuring the surface contour of an impression in impression capturing device 50 according to this invention. Contour scanning system 10 includes digital camera system 30 which comprises a pair of digital cameras 32A and 32B which are rigidly mounted to one another on a frame 34 and are located a distance “X” from one another, as well as impression capturing device 50. Cameras 32A and 32B generally each comprise an array of CCD's or other light sensitive devices. Each of the light sensitive devices generates a signal indicating the intensity of light in each pixel within the image. Cameras 32A and 32B are calibrated relative to each other utilizing software provided with cameras. Cameras 32A and 32B image beam 22 from light source 20 on a surface or a portion of impression capturing device 50, such as seat base portion 56 or seat back portion 58 as illustrated in FIGS. 1. and 2 substantially simultaneously.

Cameras 32A and 32B capture images which are then provided to central processing unit or microprocessor 40 via a digital conduit or cable 42 for analysis. As described herein, the microprocessor 40 receives the raw digital images from cameras 32A and 32B, identifies the brightest pixel in the images from the camera, identifies the positions of the brightest spots in each row of pixels, and computes the relative height for each point with respect to the reference plane. The position of reference point 51 illustrated in FIGS. 1 and 2 located on the upper surface of seat base portion 56, a distance “d” above a base plane defined by using horizontal plane of reference elements 52, is determined by using vectors or triangulation. It is a straightforward image processing task to determine the distance from a reference plane of camera system 30 to reference point 51. Likewise, any additional desired reference points on the surface of the impression capturing device 50 are measured utilizing the contour scanning system 10 of the invention. When an impression in seat back portion 58 is to be measured, vertical plane of reference elements 54 are utilized to calculate a base plane.

FIG. 1 shows the use of a laser light source 20 as described hereinabove which projects or transmits a laser beam 22, a substantially linear beam as shown in FIG. 2 onto the surface of impression capturing device 50. As noted above, the laser beam 22 is preferably a narrow width of light such as a line which by either machine or by hand can be slowly scanned over the surface of the molded shape, as from left to right and top to bottom, to continuously highlight narrow portions of the impression whereby the contours and features of the impression, and optionally, surrounding structure, are mapped, determined and captured by the contour scanning system 10 of the invention.

As described herein, in a first step, light from light source 20, i.e. laser beam 22 is cast upon three separate planar reference points or areas such as horizontal planar reference elements 52 on seat base portion 56 of the impression capturing device 50 to establish a frame of reference with regard to depth. The camera system 30 is then utilized to record the position of at least three such points, i.e. reference elements 52, on the planar surface to establish a base plane (xy) whereby z=0. Moreover, the contour scanning system 10 is set to record a minimum specific light brightness so that background, room light, and the like is screened out and not recorded as data points by the contour scanning system 10.

Once a reference plane has been determined by the contour scanning system 10, the linear laser beam source 20 is then activated and the contoured surface of the impression and any other desired surface are scanned with beam 22 in any manner, either by hand or utilizing a device or machine. During the scanning procedure, the digital stereo vision camera system 30, independently through each separate lens, captures the laser light incident upon the contoured surface numerous times each second and the camera software of the contour scanning system determines the physical location relative to the camera and hence generates three-dimensional or contour data in the form of digital signals which are conveyed or transferred via cable 42 to microprocessor 40. The data is stored by the microprocessor as an array of three-dimensional points with preferably equal spacing in the x and y directions. The data is present in a format which can be utilized by a fabricating machine. Thus, the invention is able to produce a very accurate replication of the contoured surface of an impression taken of a specific portion of an individual.

The data of the impression, etc. retained in microprocessor 40 can be utilized to reproduce an actual physical replica or support article utilizing a fabricating device 60. For example, the data relating to an impression of a specific person can be transmitted from the microprocessor to a fabrication apparatus or machine such as described and set forth in U.S. Pat. No. 4,890,325 to produce a foam seat cushion. Fabricating devices are available from Mazak of Florence, Ky., Techno-Isel of New Hyde Park, N.Y.; and Fadal Machining Centers.

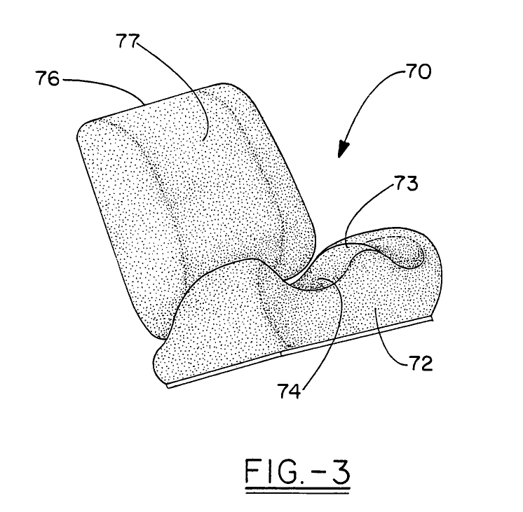

In one embodiment, data from the microprocessor is selectively communicated to the fabricating unit. In one embodiment a modem or other device of the microprocessor transmits the data via a carrier such as a telephone line, DSL, or the like to a receiving modem or other device of the fabricating device 60. Once the data have been communicated to the fabricating device 60, construction of the support article is performed. FIG. 3 illustrates a personal support article 70 fabricated utilizing the apparatus of the present invention. Support article 70 includes a seat 72, having a ridge 73 and a contoured region 74 for a person's thighs and buttocks. Seat back 76 also includes a contoured area 77 for a person's back.

The present invention thus serves to provide an apparatus and method to electronically reproduce data relating to any of numerous portions of an individual's body including buttocks, lower back, arms including elbows, wrists, fingers, and the like, legs including knees, ankles, feet, toes and the like, neck, and so forth.

Besides preferably serving as a tool from which to manufacture suitable support such as seats, seat backs, and the like, the present invention can also be utilized to form casts and braces as for broken arms and legs.

While in accordance with the patent statutes the best mode and preferred embodiment have been set forth, the scope of the invention is not limited thereto, but rather by the scope of the attached claims.

What is claimed is:

1. An apparatus for determining the surface contour of an impression of a portion of a body, comprising:
a light source capable of projecting a beam onto a surface comprising at least an impression of a portion of a body; and
a contour scanning system comprising at least two digital cameras spaced a predetermined distance from each other and operatively connected to a microprocessor, said contour scanning system capable of detecting the beam on the surface and generating a plurality of data reference points relating to the contour of the surface.

2. An apparatus according to claim 1, wherein the at least two cameras are a digital stereo vision camera.

3. An apparatus according to claim 2, wherein the light source is a laser, and wherein the apparatus further includes an impression capturing device including said surface comprising the impression of a portion of a body.

4. An apparatus according to claim 3, wherein the apparatus further includes a digital conduit digitally connecting the digital stereo vision camera to the microprocessor.

5. An apparatus according to claim 4, wherein the beam projected by the laser is substantially linear and has a length at least two times greater than a width, wherein the beam has a length of about 1 to about 60 centimeters and a width of about 0.1 to about 2 centimeters.

6. An apparatus according to claim 5, wherein the apparatus further includes a fabricating unit capable of producing a support article from the data generated by the contour scanning system.

7. An apparatus according to claim 1, wherein the impression capturing device includes at least three planar reference elements arranged in substantially a same plane.

8. An apparatus according to claim 2, wherein the digital stereo vision camera performs from 1 to about 20,000 captures per second and has a resolution of about 640×480 pixels at a 30 Hz frame rate, and wherein the digital stereo vision camera is located a distance of from about 0.5 to about 5 meters from the impression capturing device.

9. An apparatus for determining the surface contour of an impression of a portion of a body, comprising:
a laser light source capable of projecting a laser beam onto and scanning a surface of a device comprising an impression of a portion of a body;
a digital stereo vision camera capable of recording images of the surface contour of the surface as said laser beam scans the surface of said device; and
a digital conduit capable of operatively connecting said digital stereo vision camera to a microprocessor.

10. An apparatus according to claim 9, wherein the beam projected by the laser is substantially linear and has a length at least two times greater than a width, wherein the beam has a has a length of about 1 to about 60 centimeters and a width of about 0.1 to about 2 centimeters.

11. An apparatus according to claim 9, wherein the apparatus further includes a fabricating unit capable of producing a support article from the data generated by the contour scanning system.

12. An apparatus according to claim 10, wherein the device is an impression capturing device wherein the impression capturing device includes at least three planar reference elements arranged in substantially a same plane.

13. An apparatus according to claim 9, wherein the digital stereo vision camera performs from 1 to about 20,000 captures per second and has a resolution of about 640×480 pixels at a 30 H_{z} frame rate, and wherein the digital stereo vision camera is located a distance of from about 0.5 to about 5 meters from the impression capturing device.

14. An apparatus according to claim 12, wherein the digital stereo vision camera performs from 1 to about 20,000 captures per second and has a resolution of about 640×480 pixels at a 30 H_{z} frame rate, and wherein the digital stereo vision camera is located a distance of from about 1 to about 4 meters from the impression capturing device.

15. A method for preparing a support article, comprising the steps of:
forming an impression of a body part in an impression capturing device;
scanning at least a surface of the impression with a beam from a light source; and
determining location of one or more points scanned with the light source beam on at least the surface of the impression utilizing a contour scanning system.

16. A method according to claim 15, further including aiming at least two digital cameras of the contour scanning system at at least a portion of the impression.

17. A method according to claim 16, wherein the contour scanning system comprises a microprocessor, a digital stereo vision camera, and a digital conduit operatively connecting the microprocessor of the digital stereo vision camera, and wherein the light source is a laser.

18. A method according to claim 17, determining a reference plane utilizing the contour scanning system and at least three planar reference elements.

19. A method according to claim 18, determining location of essentially the brightest pixel in one or more rows of pixels captured by the digital stereo vision camera utilizing the contour scanning system.

20. A method according to claim 19, further including fabricating a personal support article utilizing data produced by the contour scanning system.

21. A method according to claim 15, determining location of essentially the brightest pixel in one or more rows of pixels captured by the digital stereo vision camera utilizing the contour scanning system.

22. A method according to claim 15, wherein the contour scanning system comprises a microprocessor, a digital stereo vision camera, and a digital conduit operatively connecting the microprocessor of the digital stereo vision camera, and wherein the light source is a laser.

23. A method according to claim 15, further including fabricating a personal support article utilizing data produced by the contour scanning system.

24. A method according to claim 23, determining a reference plane utilizing the contour scanning system.
